(19) United States
(12) Patent Application Publication
(10) Pub. No.: US 2015/0358390 A1
(43) Pub. Date: Dec. 10, 2015

(54) METHOD AND SYSTEM TO SHARE VISUAL CONTENT ACROSS A PLURALITY OF MOBILE DEVICES TO GENERATE INTEREST, SUPPORT AND FUNDING FOR PHILANTHROPIC AND FOR SOCIAL CAUSES

(71) Applicant: STAND TECHNOLOGIES, INC., Mill Valley, CA (US)

(72) Inventors: Gary STARR, Sausalito, CA (US); Eric HARR, Fairfax, CA (US)

(21) Appl. No.: 14/731,328

(22) Filed: Jun. 4, 2015

Related U.S. Application Data
(60) Provisional application No. 62/007,872, filed on Jun. 4, 2014.

(51) Int. Cl. H04L 29/08; H04L 12/58

(52) U.S. Cl. CPC H04L 67/06; H04L 51/32

(57) ABSTRACT

Method and system for sharing visual content across a plurality of mobile or computing devices to generate interest, support and/or funding for philanthropic or social causes is disclosed. The method enables the generation of interest, support and/or funding for philanthropic or social causes from a mobile application. The user downloads the application, captures one or more photos relating to a social cause. The user shares the content with his contacts and invites them to vote or donate. The person with the most number of votes, likes, other indication of interests, forwards or the most relevant social cause is displayed on the front page of the application. The votes, likes, other indication of interests, forwards that populate are considered the most relevant and the staff or program picks are possibly the ones that obtain the most votes, likes, other indication of interests, forwards.

### TECHNICAL FIELD

Embodiments of the disclosure relate generally to the field of mobile applications. Embodiments relate more particularly to sharing of visual content across a plurality of mobile devices to generate interest, support and/or funding for philanthropic or social causes through a mobile application.

### BACKGROUND

Photo-sharing is a booming market on mobile platforms with all manners of services popping up almost on a weekly basis. People now share over 500 million photos each day worldwide according to an internet trends report. One of the reasons for this staggering high number is that mobile technology has contributed to this phenomenon by making it amazingly simple and immediate for people to share photos taken with their smartphones.

Mobile technology is altering the way we experience and share images; smartphone cameras are freeing individuals to spontaneously capture candid images and instantly share them. Smartphone cameras offer a level of spontaneity and immediacy that is often liberating to people interested in capturing photos. The first and possibly big trend fuelling the photo-app craze is the ubiquity of decent camera phones. As cell phone and smartphone penetration increases and phones get exponentially better, more and more consumers are carrying high resolution cameras with them wherever they go. Mobile applications also provide immediate gratification for in-the-moment photos. Rather than taking a photo, going home, downloading it to a computer and then posting it online, photo apps allows for publishing immediately. Users get immediate distribution in addition to instant publishing. The other advantage of photo sharing through mobile phones is that since individuals carry their phones with them usually all the time, the photo apps built from the ground up with the on-the-go usability in mind are optimized for different behaviours which are conducive to quick snaps and fast social sharing.

Popular applications for mobile photo sharing include Facebook camera, Instagram, Snap chat, Flickr and photobucket. The Facebook camera is considered one of the fastest ways to share photos with your close friends and family members. One needs to browse through a feed of friends photos, upload multiple photos at once, and can add filters to make photos look unique. Instagram allows one to customize the photos and videos with custom built filter effects and cinematic stabilization. Unlimited photos and videos can be shared in a photostream and one can even post photos to Facebook, twitter, flickr, tumblr and foursquare. Snapchat is a unique way to share personal photos and funny videos with friends. One needs to snap a photo or video and send it to the friends which will instantly disappear after they view it. Flickr lets users take stunning photos with the apps easy-to-use camera and instantly share images with Flickr groups, Facebook, Twitter, and Tumblr. One can enhance his/her photos by using built in filters, editing features, and geo-tagging. Flickr is also considered the best way to share high-resolution photos. Photo bucket lets users upload and manage photos wherever they are. It helps easily create, organize, and edit albums. One can use swipe gestures and browse through photo galleries and share photos and albums to Facebook, twitter and email.

However, all the above mentioned mobile applications and other existing applications do not provide a platform for allowing others to designate or relate such content to a stand for what they may believe in. For example, the stand could be a walk for cancer survivors or a crusade against animal testing in labs. In the light of the above discussion, there appears to be a need for a mobile application which allows the user to designate or relate content to a stand for what they believe in, or to support or contribute immediately to the stand they believe in by allowing one to post their cause with a simple photo.

### OBJECT OF INVENTION

The principal object of the embodiments herein is to provide a method and system to share visual content across a plurality of mobile devices to generate interest, support and/or funding for philanthropic or social causes through a mobile application.

### SUMMARY

The above-mentioned needs are met by a computer-implemented method, a system and a computer program product for sharing visual content across a plurality of mobile devices to generate interest, support and/or funding for philanthropic or social causes through a mobile application.

An example of a method for sharing visual content across a plurality of mobile devices to generate interest, support and/or funding for philanthropic or social causes through a mobile application is disclosed. The method includes capturing visual content and analyzing frames of the sequence to identify one or more social cause objects. Further, the method includes presenting the selected one or more frames to a first user. Furthermore, the method includes determining a value of the frames based on the one or more identified social cause objects. Moreover, the method includes inviting users to share or provide at least one vote, at least one like or other indication of interest, at least one forward or at least one donation.

An example of a system for sharing visual content across a plurality of mobile devices to generate interest, support and/or funding for philanthropic or social causes through a mobile application is disclosed. The system includes a client device configured with one of a camera and a camera function to capture one or more media files in real time. Further, the system includes a processor coupled within the client device and configured to capture a set of photos or related content and analyzing frames of the sequence to identify one or more social cause objects, present the selected one or more frames to a first user, determine a value of the frames based on the one or more identified social cause objects and invite users to share or provide at least one vote, at least one like or other indication of interest, at least one forward or at least one donation.

An example of a computer program product for sharing visual content across a plurality of mobile devices to generate interest, support and/or funding for philanthropic or social causes through a mobile application is disclosed. The computer program product includes capturing a set of photos or related content and analyzing frames of the sequence to identify one or more social cause objects. Further, the computer program product includes presenting the selected one or more frames to a first user. Furthermore, the computer program product includes determining a value of the frames based on the one or more identified social cause objects. Moreover, the computer program product includes inviting users to share or provide at least one vote, at least one like or other indication of interest, at least one forward or at least one donation.

These and other aspect of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the present disclosure.

FIG. 1 is a block diagram of a content-sharing system, according to the embodiments as disclosed herein;

FIG. 2 illustrates the example content sharing system 100, which may be used with some embodiments of the present invention;

FIG. 3 is a flow diagram depicting the process of using the application of the present invention, according to the embodiments as disclosed herein

FIG. 4 is an exemplary representation of the screen shot of the application, according to the embodiments as disclosed herein;

FIGS. 5a to 5h depicts exemplary screen shots showcasing the entire range of the application, according to the embodiments as disclosed herein; and

FIG. 6 is an exemplary screen shot to describe a location, according to the embodiments as disclosed herein.

### DETAILED DESCRIPTION OF THE EMBODIMENTS

The above-mentioned needs are met by a method and system for enabling sharing of visual content on a mobile application across a plurality of computing devices to generate interest, support and/or funding for philanthropic or social causes. The following detailed description is intended to provide example implementations to one of ordinary skill in the art, and is not intended to limit the invention to the explicit disclosure, as one of ordinary skill in the art will understand that variations can be substituted that are within the scope of the invention as described.

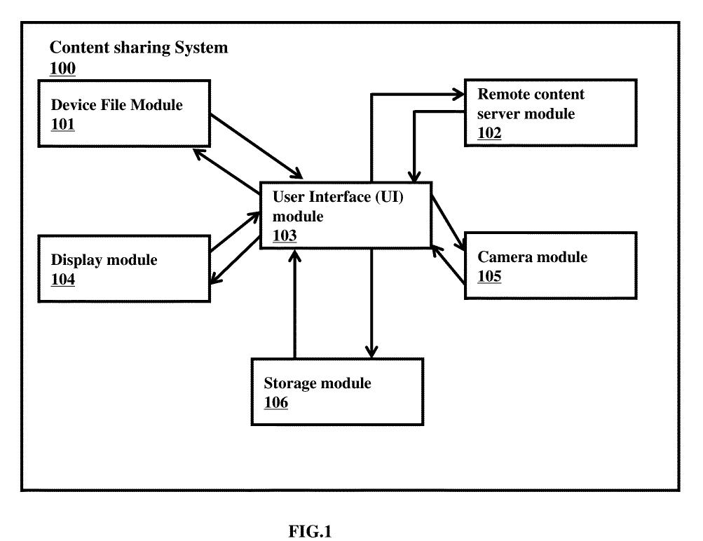

FIG. 1 is a block diagram of a Content-sharing system, according to the embodiments as disclosed herein. The Content sharing system 100 includes a device file module 101 and is installed on a plurality of mobile devices that may communicate with the device file module 101 via one or more network links. In various embodiments, the device file module 101 may actually comprise one or more servers and a storage module 106, one or more of which may or may not be physically located within the physical boundaries of the enterprise.

Network link(s) may include any suitable number or arrangement of interconnected networks including both wired and wireless networks. By way of example, a wireless communication network link over which mobile devices communicate may utilize a cellular-based communication infrastructure. The communication infrastructure includes cellular-based communication protocols such as AMPS, CDMA, TDMA, GSM (Global System for Mobile communications), iDEN, GPRS, EDGE (Enhanced Data rates for GSM Evolution), UMTS (Universal Mobile Telecommunications System), WCDMA and their variants, among others. In various embodiments, a network link may further include, or alternately include, a variety of communication channels and networks such as WLAN/Wi-Fi, WiMAX, Wide Area Networks (WANs), and Blue-Tooth.

The Content-sharing system 100 may be operably connected with (or included within) an enterprise network. The Enterprise network may further include one or more of email or exchange servers, enterprise application servers, internal application store servers, authentication (AAA) servers, directory servers, Virtual Private Network (VPN)/SSL gateways, firewalls, among other servers and components. Email or exchange servers may include Exchange Active Sync (EAS) or other functionality that provides synchronization of contacts, calendars, tasks, and email between Active sync enabled servers and mobile devices. Other synchronization products can also be used. The mobile devices may access or utilize one or more of these enterprise systems or associated functionality.

In certain embodiments, server and/or the mobile development service may be hosted and operated by one or more third-party service providers and/or may be accessed by developers through network using a developer computer. In certain embodiments, network may be any suitable type of wired and/or wireless network such as an Internet network or dedicated network that allows developers to access to a Remote content server module 102 through developer computer. For example, as shown in FIG. 1, the Remote content server module 102 may be in the form of a web server that can be accessed by developers through the Internet using developer computer.

Developers may access the mobile development service by navigating to one or more web pages using a standard web browser on developer computer, thereby obviating the need to download and/or install separate software on a developer computer. In certain other embodiments, the mobile development service may be a separate client or stand-alone software application that can be downloaded by developers from server and/or one or more other third-party servers, or may be provided to developers through any other suitable means (e.g., CD, physical disk, etc.) and installed on a developer computer. Although the Remote content server module 102 is shown in FIG. 1 for illustrative purposes, it should be understood that in certain embodiments the functionality provided by the Remote content server module 102, such as the mobile development service, may be hosted and operated by any number of servers, or may be integrated with developer computer.

In certain of these embodiments, developers can design, create and/or modify a mobile app by defining (e.g., selecting, creating, customizing and/or uploading) various application components, such as app-types and modules, design elements, such as layouts, themes and display options, and content elements, such as test, images, videos, sounds, songs, documents, and other similar data for the app of the Content sharing system 100.

As depicted in FIG. 1, the User Interface (UI) module 103 may also include a display device, a processor accessible memory, or any device or combination of devices to which data is output. The UI module 103 interfaces with the camera module 105 to obtain the captured images in real time and provides the captured images.

In some embodiments, content sharing is not limited only to images or pictures but can also be extended to video files, audio files or any other suitable format.

In an embodiment, sets of images that are captured at capture locations within a pre-defined distance of each other can be designated to be similar digital images. Likewise, sets of digital images that are captured within a pre-defined capture time range may be designated to be in a group of similar images.

The camera module 105 interacts with the camera device driver to provide and render the camera preview frames. Further, the camera module 105 allows the UI module 103 to capture the image in a plurality of ways.

The storage module 106 acts like a database and stores the images, videos audio and other related data on the user device.

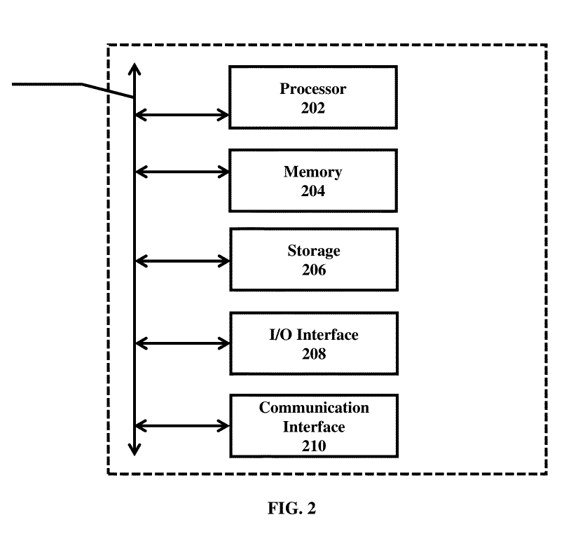

FIG. 2 illustrates an example content sharing system 100, which may be used with some embodiments of the present invention.

The content sharing system 100, such as a mobile application, enables its users to interact with it and with each other through the system. Typically, to become a registered user of content sharing system 100, an entity, either human or non-human, registers for an account with the content sharing system 100. Thereafter, the registered user may log into the system 100 via an account by providing, for example, a login ID or username and password. As used herein, a “user” may be an individual (human user), an entity (e.g., an enterprise, business, or third party application), or a group (e.g., of individuals or entities) that interacts or communicates with or over such a social network environment.

When a user registers for an account with the system 100, the system 100 may create and store a record, often referred to as a “user profile”, in connection with the user. The user profile may include information provided by the user and information gathered by various systems, including the system 100, relating to activities or actions of the user. For example, the user may provide his name, profile picture, contact information, birth date, gender, marital status, family status, employment, education background, preferences, interests, and other demographical information to be included in his user profile. The user may identify other users of the system 100 that the user considers to be his friends. A list of the user's friends or first degree contacts may be included in the user's profile. Connections in social networking systems may be in both directions or may be in just one direction. For example, if Bob and Joe are both users and connect with each another, Bob and Joe are each connections of the other. If, on the other hand, Bob wishes to connect to Sam to view Sam's posted content items, but Sam does not choose to connect to Bob, a one-way connection may be formed where Sam is Bob's connection, but Bob is not Sam's connection. Some embodiments of the system 100 allow the connection to be indirect via one or more levels of connections (e.g., friends of friends). Connections may be added explicitly by a user, for example, the user selecting a particular other user to be a friend, or automatically created by the system 100 based on common characteristics of the users (e.g., users who are alumni of the same educational institution). The user may identify or bookmark websites or web pages he visits frequently and these websites or web pages may be included in the user's profile.

The user may provide information relating to various aspects of the user (such as contact information and interests) at the time the user registers for an account or at a later time. The user may also update his or her profile information at any time. For example, when the user moves, or changes a phone number, he may update his contact information. Additionally, the user's interests may change as time passes, and the user may update his interests in his profile from time to time. A user's activities on the system 100, such as frequency of accessing particular information on the system 100, may also provide information that may be included in the user's profile. Again, such information may be updated from time to time to reflect the user's most-recent activities. Still further, other users or so-called friends or contacts of the user may also perform activities that affect or cause updates to a user's profile. For example, a contact may add the user as a friend (or remove the user as a friend). A contact may also write messages to the user's profile pages typically known as wall-posts. A user may also input status messages that get posted to the user's profile page.

The system 100 may maintain social graph information, which can generally model the relationships among groups of individuals, and may include relationships ranging from casual acquaintances to close familial bonds. A social network may be represented using a graph structure. Each node of the graph corresponds to a member of the social network. Edges connecting two nodes represent a relationship between two users. In addition, the degree of separation between any two nodes is defined as the minimum number of hops required to traverse the graph from one node to the other. A degree of separation between two users can be considered a measure of relatedness between the two users represented by the nodes in the graph.

The Content sharing system 100 may support a variety of applications, such as photo sharing, on-line calendars and events. For example, the system 100 may also include media sharing capabilities. In another example, the system 100 may also allow users to post photographs and other multimedia files to a user's profile, such as in a wall post or in a photo album, both of which may be accessible to other users of the system 100. Social networking system may also allow users to configure events. For example, a first user may configure an event with attributes including time and date of the event, location of the event and other users invited to the event. The invited users may receive invitations to the event and respond (such as by accepting the invitation or declining it). Furthermore, the system 100 may allow users to maintain a personal calendar. Similarly to events, the calendar entries may include times, dates, locations and identities of other users.

The system 100 may also support a privacy model. A user may or may not wish to share his information with other users or third-party applications, or a user may wish to share his information only with specific users or third-party applications. A user may control whether his information is shared with other users or third-party applications through privacy settings associated with his user profile. For example, a user may select a privacy setting for each user datum associated with the user and/or select settings that apply globally or to categories or types of user profile information. A privacy setting defines, or identifies, the set of entities (e.g., other users, connections of the user, friends of friends, or third party application) that may have access to the user datum. The privacy setting may be specified on various levels of granularity, such as by specifying particular entities in the social network (e.g., other users), predefined groups of the user's connections, a particular type of connection, all of the user's connections, all first-degree connections of the user's connections, the entire social network, or even the entire Internet (e.g., to make the posted content item index-able and searchable on the Internet). A user may choose a default privacy setting for all user data that is to be posted. Additionally, a user may specifically exclude certain entities from viewing a user datum or a particular type of user data.

The system 100 may maintain a database of information relating to geographic locations or places. Places may correspond to various physical locations, such as restaurants, bars, train stations, airports and the like. In one implementation, each place can be maintained as a hub node in a social graph or other data structure maintained by the system 100. The system 100 may allow users to access information regarding each place using a client application (e.g., a browser) hosted by a wired or wireless station, such as a laptop, desktop or mobile device. For example, the system 100 may serve web pages (or other structured documents) to users that request information about a place. In addition to user profile and place information, the system 100 may track or maintain other information about the user. For example, the social networking system may support geo-social networking system functionality including one or more location-based services that record the user's location. For example, users may access the geo-social networking system using a special-purpose client application hosted by a mobile device of the user (or a web- or network-based application using a browser client). The client application may automatically access Global Positioning System (GPS) or other geo-location functions supported by the mobile device and report the user's current location to the geo-social networking system. In addition, the client application may support geo-social networking functionality that allows users to check-in at various locations and communicate this location to other users. A check-in to a given place may occur when a user is physically located at a place and, using a mobile device, access the geo-social networking system to register the user's presence at the place. A user may select a place from a list of existing places near to the user's current location or create a new place. The system 100 may automatically check in a user to a place based on the user's current location and past location data. An entry including a comment and a time stamp corresponding to the time the user checked in may be displayed to other users. For example, a record of the user's check-in activity may be stored in a database. The system 100 may select one or more records associated with check-in activities of users at a given place and include such check-in activity in web pages (or other structured documents) that correspond to a given place. The check-in activity may also be displayed on a user profile page and in news feeds provided to users of the system 100.

Still further, a special purpose client application hosted on a mobile device of a user may be configured to continuously capture location data of the mobile device and send the location data to the system 100. In this manner, the system 100 may track the user's location and provide various recommendations to the user related to places that are proximal to the user's path or that are frequented by the user. In one implementation, a user may opt in to this recommendation service, which causes the client application to periodically post location data of the user to the system 100.

This present invention contemplates system 100 taking any suitable physical form. As example and not by way of limitation, the system 100 may be an embedded computer system, a system-on-chip (SOC), a desktop computer system, a mobile computer system, a game console, a mainframe, a mesh of computer systems, a server, or a combination of two or more of these. Where appropriate, the system 100 may include one or more computer systems 100; be unitary or distributed; span multiple locations; span multiple machines; or reside in a cloud, which may include one or more cloud components in one or more networks. Where appropriate, one or more computer systems 100 may perform without substantial spatial or temporal limitation one or more steps of one or more methods described or illustrated herein. As an example and not by way of limitation, one or more computer systems 100 may perform in real time or in batch mode one or more steps of one or more methods described or illustrated herein. One or more computer systems 100 may perform at different times or at different locations one or more steps of one or more methods described or illustrated herein, where appropriate.

In particular embodiments, computer system 100 includes a processor 202, memory 204, storage 206, an input/output (I/O) interface 208, a communication interface 210, and a bus 212. In particular embodiments, processor 202 includes hardware for executing instructions, such as those making up a computer program. As an example and not by way of limitation, to execute instructions, processor 202 may retrieve (or fetch) the instructions from an internal register, an internal cache, memory 204, or storage 206; decode and execute them; and then write one or more results to an internal register, an internal cache, memory 204, or storage 206. In particular embodiments, processor 202 may include one or more internal caches for data, instructions, or addresses. In particular embodiments, memory 204 includes main memory for storing instructions for processor 202 to execute data for processor 202 to operate on. As an example and not by way of limitation, computer system 100 may load instructions from storage 206 to memory 204. Processor 202 may then load the instructions from memory 204 to an internal register or internal cache. To execute the instructions, processor 202 may retrieve the instructions from the internal register or internal cache and decode them. During or after execution of the instructions, the processor 202 may write one or more results (which may be intermediate or final results) to the internal register or internal cache. Processor 202 may then write one or more of those results to memory 204. One or more memory buses (which may each include an address bus and a data bus) may couple processor 202 to memory 204. Bus 212 may include one or more memory buses, as described below. In particular embodiments, one or more memory management units (MMUs) reside between processor 202 and memory 204 and facilitate accesses to memory 204 requested by processor 202. In particular embodiments, memory 204 includes random access memory (RAM). This RAM may be volatile memory, where appropriate Where appropriate, this RAM may be dynamic RAM (DRAM) or static RAM (SRAM).

In particular embodiments, storage 206 includes mass storage for data or instructions. As an example and not by way of limitation, storage 206 may include an HDD, a floppy disk drive, flash memory, an optical disc, a magneto-optical disc, magnetic tape, or a Universal Serial Bus (USB) drive or a combination of two or more of these. Storage 206 may include removable or non-removable (or fixed) media, where appropriate. Storage 206 may be internal or external to computer system 100, where appropriate. In particular embodiments, storage 206 is non-volatile, solid-state memory. In particular embodiments, storage 206 includes read-only memory (ROM). Where appropriate, this ROM may be mask-programmed ROM, programmable ROM (PROM), erasable PROM (EPROM), or flash memory or a combination of two or more of these.

In particular embodiments, I/O interface 208 includes hardware, software, or both providing one or more interfaces for communication between computer system 100 and one or more I/O devices. Computer system 100 may include one or more of these I/O devices, where appropriate. One or more of these I/O devices may enable communication between a person and computer system 100. As an example and not by way of limitation, an I/O device may include a keyboard, microphone, display, touch screen, mouse, speaker, camera, another suitable I/O device or a combination of two or more of these. An I/O device may include one or more sensors. This disclosure contemplates any suitable I/O devices and any suitable I/O interfaces 208 for them. Where appropriate, I/O interface 208 may include one or more device or software drivers enabling processor 202 to drive one or more of these I/O devices. I/O interface 208 may include one or more I/O interfaces 208, where appropriate. Although this disclosure describes and illustrates a particular I/O interface, this disclosure contemplates any suitable I/O interface.

In particular embodiments, communication interface 210 includes hardware, software, or both providing one or more interfaces for communication (such as, for example, packet-based communication) between computer system 100 and one or more other computer systems 200 or one or more networks. As an example and not by way of limitation, communication interface 210 may include a network interface controller (NIC) for communicating with an Ethernet or other wire-based network or a wireless NIC (WNIC) for communicating with a wireless network, such as a WI-FI network. This disclosure contemplates any suitable network and any suitable communication interface 210 for it. As an example and not by way of limitation, computer system 100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 100 may communicate with a wireless PAN (WPAN) (e.g., a BLUETOOTH WPAN), a WI-FI network (e.g., a 802.11a/b/g/n WI-FI network), a WI-MAX network, a cellular telephone network (e.g., a Global System for Mobile Communications (GSM) network, a Long Term Evolution (LTE) network), or other suitable wireless network or a combination of two or more of these.

In particular embodiments, bus 212 includes hardware, software, or both coupling components of computer system 200 to each other. As an example and not by way of limitation, bus 212 may include an Accelerated Graphics Port (AGP) or other graphics bus, an Enhanced Industry Standard Architecture (EISA) bus, a front-side bus (FSB), a HYPERTRANSPORT (HT) interconnect, an INFINIBAND interconnect, a low-pin-count (LPC) bus, a memory bus, a Peripheral Component Interconnect Express or PCI-Express bus, a serial advanced technology attachment (SATA) bus, an Inter-Integrated Circuit (12C) bus, a Secure Digital (SD) memory interface, a Secure Digital Input Output (SDIO) interface, a Universal Serial Bus (USB) bus, a General Purpose Input/Output (GPIO) bus, or another suitable bus or a combination of two or more of these. Bus 212 may include one or more buses 212, where appropriate.

The client-side functionality described above can be implemented as a series of instructions stored on a computer-readable storage medium that, when executed, cause a programmable processor to implement the operations described above. While the client device 104 may be implemented in a variety of different hardware and computing systems.

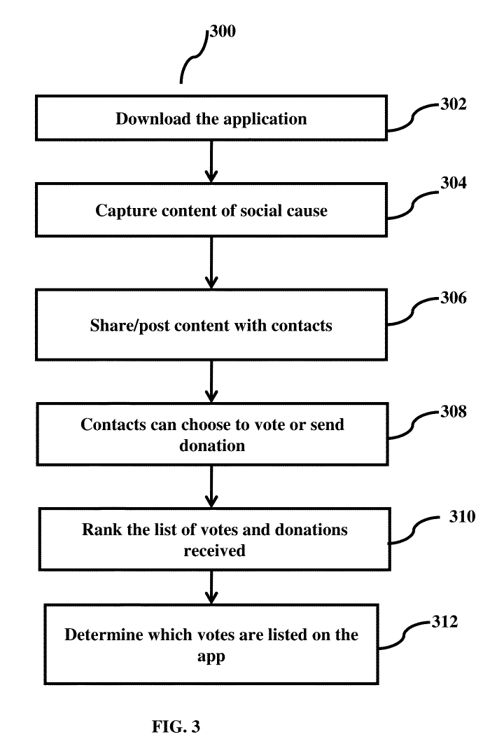

FIG. 3 is a flow diagram depicting the process of using the application of the present invention, according to the embodiments as disclosed herein.

As depicted in FIG. 3, initially the user downloads the application of the present invention. At step 302, the application can be downloaded from the Google play store in Android Phones or the App store on the I phones and other similar application downloading portals on other smartphones. The Application of the content sharing system 100 can be either one of Free or Paid version. The paid version may offer some more facilities for users compared to the free version. Once the application has been completely installed on the device of the user, the user can use the application to capture photos at step 304. The photos captured usually relate to a social cause. For example social cause can be defined as a cause identified with the society and the environment as a whole. The cause could range from photos of indiscriminate cutting of trees, groups of homeless people lying in the cold or any depiction of cruelty towards animals.

In particular embodiments, a user of the system 100 may upload one or more media files to media database. For example, a user can upload a photo or a set of photos (often called a photo album), or a video clip (or an audio clip) to a media database from a client device (e.g., a computer, or a camera phone). The user describes his stand in 140 characters or less and explains the monetary value it requires. The user may further select one or more privacy settings for each of the uploaded media files (e.g., accessible to only first-degree connections, accessible to only first- and second-degree connections, accessible to all users of the social networking system). In particular embodiments, the one or more media files may contain metadata (often called “tags”) associated with each media file. For example, a photo shot by a digital camera may contain metadata relating to file size, resolution, time stamp, name of the camera maker, and/or location (e.g., GPS) coordinates.

A user can add additional metadata values to a photo, or tag a photo, during or in connection with an upload process. Some examples of tags of a media file are author, title, comments, event names, time, location, names of people appearing in the media file, or user comment. In one implementation, the client device may implement the Exchangeable image file format (Exif), or a modified version thereof. In particular embodiments, a user may tag a media file by using a client application (e.g., a photo or video editor), or entering one or more tags in a graphical user interface of a media uploading tool that uploads a user's one or more media files from a client device to the social networking system. A user may also tag a media file after an upload at a later time in the social networking system's web site.

Therefore, at step 306 the user shares or posts social cause related content with the list of contacts. The photo and related information (e.g., one or more privacy settings) may be stored in a particular node of a social graph, while the association between the photo and the second user may be stored in an edge connecting the particular node and a user node for the second user. For example, in response to a user's request, the system 100 may, based on the one or more privacy settings, display the photo with a tag corresponding to the second user, while the tag comprises a link to a webpage (e.g., a user profile page) associated with the second user. In particular embodiments, the system 100 may also extract metadata from a media file and store the metadata in media database.

A user can use a digital camera or a camera function provided by a mobile device (e.g., a mobile phone, a tablet computer) to capture photos. The user can aim at one or more desired objects, as displayed in the viewfinder, and click on hardware button (or a software button displayed in graphical user interface), causing the camera function to capture a photo and store the photo in a local storage (e.g., an SD card or FLASH memory) of mobile device. Although the camera function operates in a photo-capturing mode, the camera function may continuously capture video when the camera function is activated. For example, a viewfinder of a camera function of a mobile device can be a real-time video feed of the camera function.

Once the photo has been shared with the contact of the first user, the contacts after examining the content and determining the relevancy of the social cause can choose to either vote or send a donation. The embodiments of the present invention allow users to make a platform to stand for what they believe in. One can tweet or send an e-mail about how a movement has encouraged them to use the application to demonstration that they stand for what they believe in. The application of the content sharing system allows the users to use the application to demonstration that they stand what they believe in, or to support or contribute immediately to the stand they believe in.

Further, the present invention enables one to post their cause with one photo. For example, a person sees a redwood tree that needs to be saved, so the person just needs to point and take a photo of the redwood tree and click. A click on the photo tells a bit more about why this tree is so important. The user then tweets, or Facebooks to their network. With this click one can either vote or send a donation. The donation can be in form of any suitable currency. After one votes, likes, indicates interests, forwards or sends donations in the form of currency, the cause gets shared with other followers and invites them to join the stand.

The ones with the most votes, likes, other indication of interests, forwards at the end of the month receive funding through NGO's/foundations and the ones with the most important issues of the month receive additional donations through MAS sales. This APP will automatically match qualified Non-profits with the cause. This vetting process eliminates the fraud being associated with all crowd-funding websites and portals.

At step 310, the list of votes, likes, other indication of interests, forwards and donations received are ranked after a pre-defined duration. For example, the last day to contribute the cause could be 15 days from when the invite was sent. Based on the ranking results, the votes, likes, other indication of interests, forwards which are listed on the app are determined to be showcased on the pages of the application. Other parameters for ranking results are staff picks, searches by most relevant causes and proximity to the clicked location.

The present invention facilitates sharing of content between a plurality of similar applications. For example even if a user has not downloaded the application of the content sharing system 100, he can still receive the content. The UI module 103 is built to accommodate unlimited share Application Programming Interfaces (API). The Application once downloaded on the user device occupies a space in the range of 25-30 Mb. The photo assets are downloaded from the server of the API and then cached for increased loading performance on the user device.

The Application also requires periodical updating and the user is usually intimated through a notification. A user account can be created in several ways such as e-mail verification, Facebook twitter and so on. Further explicit content can also be flagged as inappropriate by using a moderator which the administrator can manage or review and delete if required. When a user decides to make a payment the entire process is secure and authenticated. The payment process helps the user retrieve activity reports for the processed payments, refunds and deposits with the square connect API.

Essentially, the present invention enables using a photo to instantly raise money for a variety of social causes. The electronic device used to capture the photo is capable of instantly raising money for a cause based issue, for instance by using a credit card. This process allows the user to quickly identify and match the cause category. A user can quickly match the cause with a vetted non-profit by matching with API provided by an application called Guidestar. Additionally, the user can quickly identify and match it with the cause category.

The present invention seeks to achieve an established crowd-funding platform which is simple, mobile and credible. The embodiments allow a user with a mobile device to create a sustainable technology which allows anyone from anywhere to designate and share a stand in which they believe. A user can design and deploy a global campaign to generate interest, support and/or funding for philanthropic or social causes instantly anywhere from their electronic computing device in 30 seconds or less. The User interface of the present invention is clean, elegant and intuitive. The product structure is simple and users can seamlessly share campaigns and raise funds.

The present invention can also be considered an application of action or an action related cause. For example, if one person hears of a cause or a natural disaster on a news bulletin then on communication mediums such as television, radio, newspaper or the internet the Application can be instantly realized either to raise money or to make a donation to the cause or disaster.

In another example, if a person is walking or driving past a scene of chaos or mayhem then the person can click a picture and indicate their willingness to stand for causes such as saving a local piece of land for a park or for helping a local homeless person or to build an orphanage or a food drive for children in need and so on.

As described herein, computer software products can be written in any of various suitable programming languages, such as C, C++, C#, Pascal, Fortran, Perl, Matlab (from MathWorks), SAS, SPSS, JavaScript, AJAX, and Java. The computer software product can be an independent application with data input and data display modules. Alternatively, the computer software products can be classes that can be instantiated as distributed objects. The computer software products can also be component software, for example Java Beans (from Sun Microsystems) or Enterprise Java Beans (EJB from Sun Microsystems). Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standards 802.11, 802.11a, 802.11b, 802.11e, 802.11g, 802.11i, and 1802.11n). In one example, signals from the computer can be transferred, at least in part, wirelessly to components or other computers.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

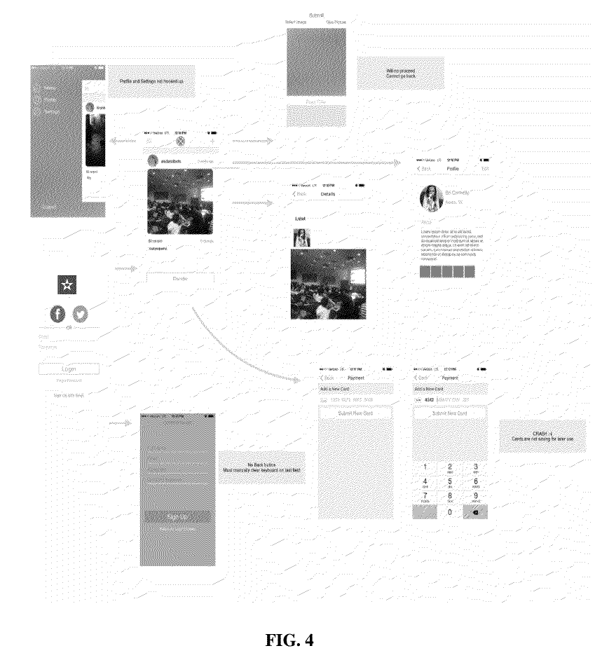

FIG. 4 is an exemplary representation of the screen shot of the application, according to the embodiments as disclosed herein.

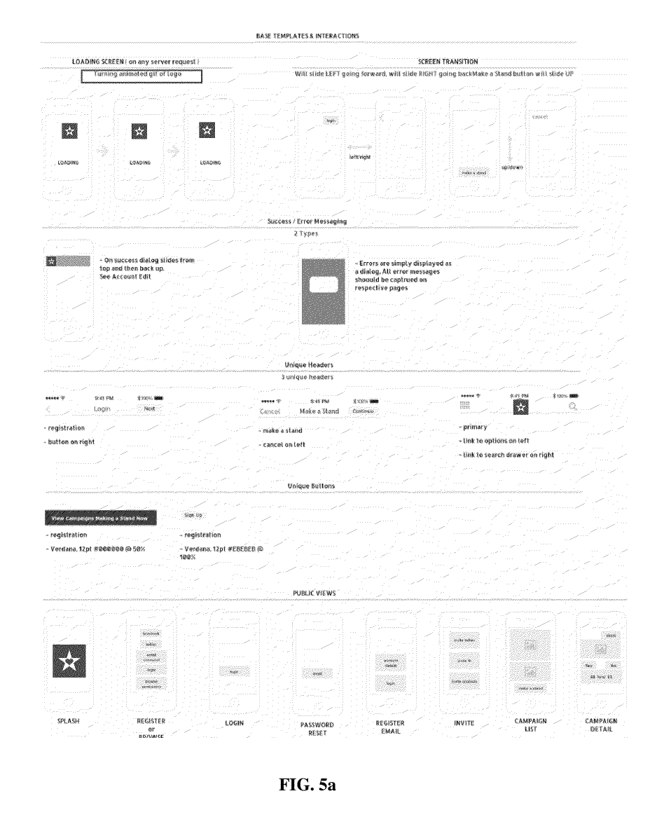

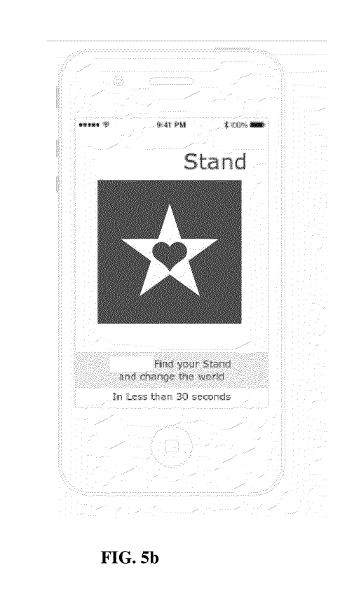

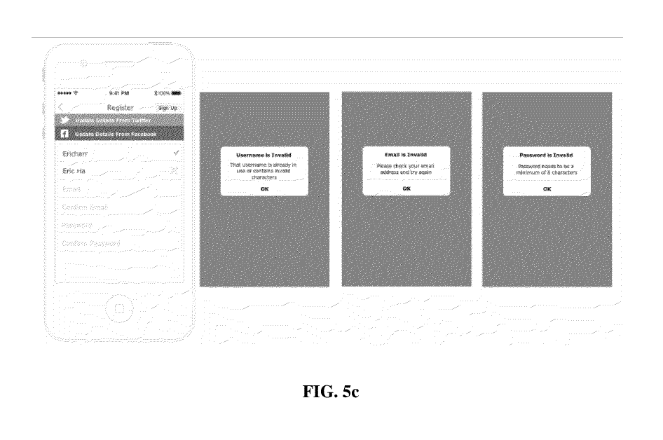

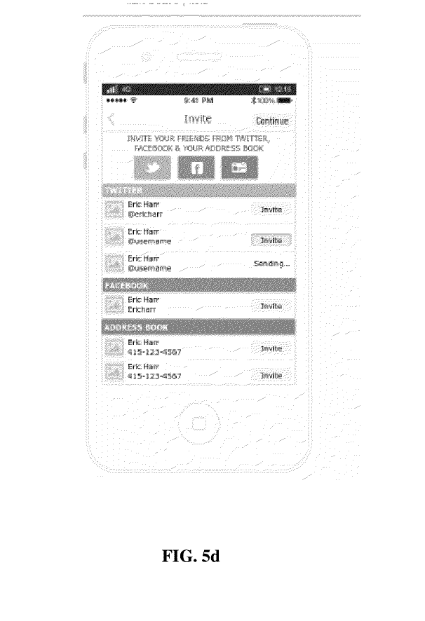

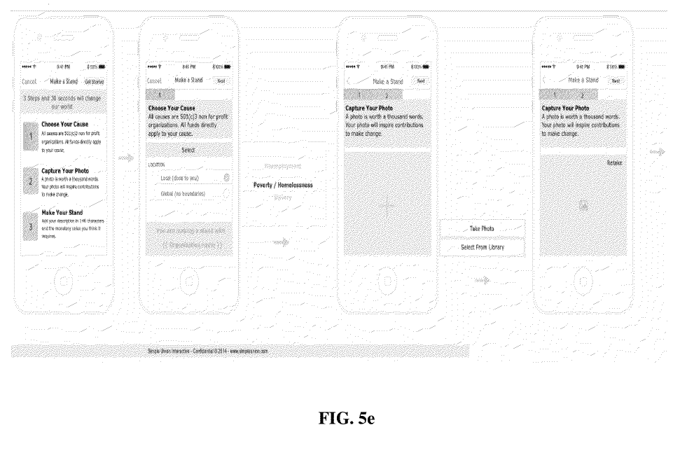

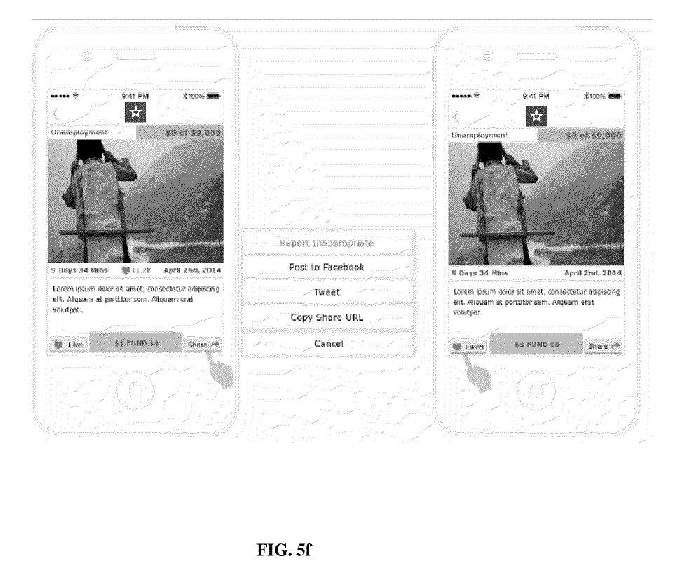

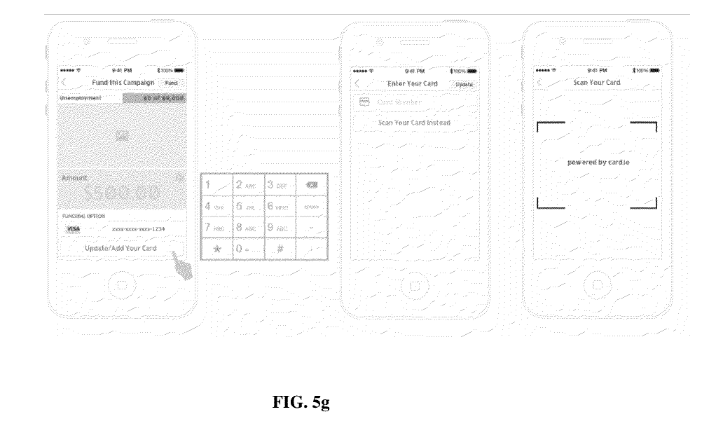

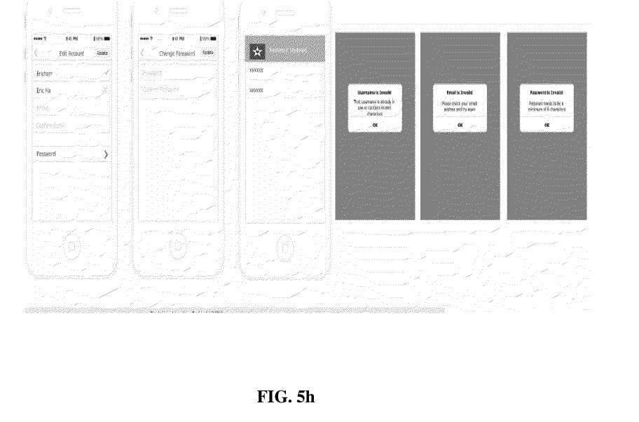

FIGS. 5a to 5h depicts exemplary screen shots showcasing the entire range of the application, according to the embodiments as disclosed herein.

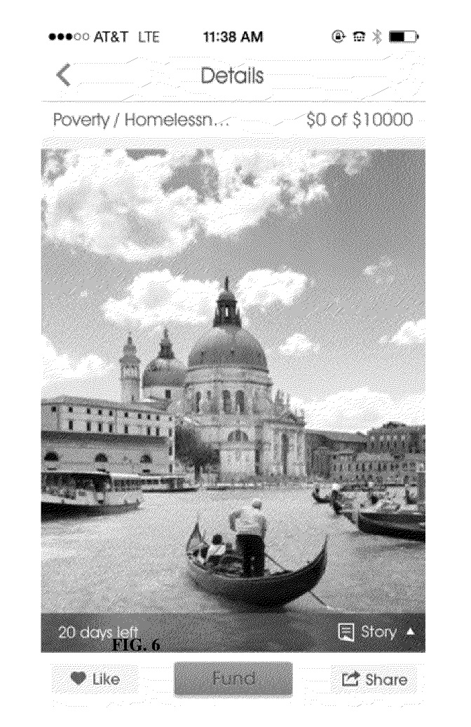

FIG. 6 is an exemplary screen shot to describe a location, according to the embodiments as disclosed herein.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Accordingly, the disclosure of the present invention is intended to be illustrative, but not limiting, of the scope of the invention, which is set forth in the following claims.

What is claimed is:

1. A computer-implemented method for sharing visual content across a plurality of mobile devices to seek funding for social causes through a mobile application, the method comprising:
capturing visual content;
analyzing frames of the sequence to identify one or more social cause objects;
presenting the selected one or more frames to a first user;
determining a value of the frames based on the one or more identified social cause objects; and
inviting users to share or provide at least one vote, at least one like, other indication of interest, at least one forward or at least one donation.

2. The computer-implemented method of claim 1 and further comprising:
downloading the mobile application to share the visual content to generate interest, support and/or funding for philanthropic or social causes through a user interface.

3. The computer-implemented method of claim 1, wherein the set of photos or related content and analyzing frames are captured through the mobile application.

4. The computer-implemented method of claim 1 and further comprising:
uploading one or more media files to a media database along with a description and monetary value;
selecting one more privacy settings for each of the uploaded media files; and
adding metadata values to the media files during uploading.

5. The computer-implemented method of claim 1 and further comprising:
storing the media files and related information in a particular node of a social graph.

6. The computer-implemented method of claim 1 wherein the votes, likes, other indication of interests, forwards and donations received are ranked after a pre-defined duration.

7. The computer-implemented method of claim 6 and further comprising:
determining the votes, likes, other indication of interests, forwards listed on the mobile application to showcase on the pages of the mobile application.

8. The computer-implemented method of claim 7 wherein the user with the most number of votes or the most relevant social cause is displayed on the front page of the application.

9. A computer program product stored on a non-transitory computer-readable medium that when executed by a processor, performs a method for sharing visual content across a plurality of mobile devices to generate interest, support and/or funding for philanthropic or social causes through a mobile application, the computer program product comprising:
capturing a set of photos or related content and analyzing frames of the sequence to identify one or more social cause objects;
presenting the selected one or more frames to a first user;
determining a value of the frames based on the one or more identified social cause objects; and
inviting users to share or provide at least one vote, at least one like, other indication of interest, at least one forward or at least one donation.

10. The computer program product of claim 9 and further comprising:
downloading the mobile application to share the visual content to generate interest, support and/or funding for philanthropic or social causes through a user interface.

11. The computer program product of claim 9, wherein the set of photos or related content and analyzing frames are captured through the mobile application.

12. The computer program product of claim 9 and further comprising:
uploading one or more media files to a media database along with a description and monetary value;
selecting one more privacy settings for each of the uploaded media files; and
adding metadata values to the media files during uploading.

13. The computer program product of claim 9 and further comprising:
storing the media files and related information in a particular node of a social graph.

14. The computer program product of claim 9 wherein the votes, likes, other indication of interests, forwards and donations received are ranked after a pre-defined duration.

15. The computer program product of claim 14 and further comprising:
determining the votes listed on the mobile application to showcase on the pages of the mobile application.

16. The computer program product of claim 15 wherein the user with the most number of votes, likes, other indication of interests, forwards or the most relevant social cause is displayed on the front page of the application.

17. A system for sharing visual content across a plurality of mobile devices to generate interest, support and/or funding for philanthropic or social causes through a mobile application, the system comprising:
a client device configured with one of a camera and a camera function to capture one or more media files in real time; and
a processor coupled within the client device and configured to perform:
capturing a set of photos or related content and analyzing frames of the sequence to identify one or more social cause objects;
presenting the selected one or more frames to a first user;
determining a value of the frames based on the one or more identified social cause objects; and
inviting users to share or provide at least one vote, at least one like, other indication of interest, at least one forward or at least one donation.

18. The system of claim 17 wherein the client device further comprises:
a user interface module to accommodate unlimited Application Programming Interfaces.

19. The system of claim 18 and further comprising:
a media database coupled to the user interface module, to store the media files and related information in a particular node of a social graph;
a device file module coupled to the user interface module;
a display module coupled to the user interface module, to display the captured media files; and
a remote content server module coupled to the user interface module.

20. The system of claim 19 wherein the display module displays the most number of votes, likes, other indication of interests, forwards or the most relevant social cause on the front page of the application.
